(19) United States
(12) Patent Application Publication
(10) Pub. No.: US 2015/0214652 A1
(43) Pub. Date: Jul. 30, 2015

(54) Electrical Plug Cover

(71) Applicant: Ashur Avedeen Thomaszadeh, Los Angeles, CA (US)

(72) Inventor: Ashur Avedeen Thomaszadeh, Los Angeles, CA (US)

(21) Appl. No.: 14/167,780

(22) Filed: Jan. 29, 2014

(51) Int. Cl. H01R 13/44; H01R 24/28

(52) U.S. Cl. CPC H01R 13/44; H01R 24/28; H01R 2103/00

(57) ABSTRACT

An electrical plug cover is an apparatus that protects a user from accidentally contacting the exposed prongs of an electrical plug. The electrical plug cover occludes the metal blades or prongs of an electrical plug while the plug is being inserted into or removed from an electrical socket or when improperly inserted into an electrical socket. The apparatus accomplishes this through a flexible low profile cover that partially surrounds the exposed prongs when they are being inserted into the electrical socket. The flexible low profile cover is positioned on the interfacing surface of an existing electrical plug that becomes coincident with the interfacing surface of an electrical socket. The electrical plug cover is compressed between the interfacing surfaces of the electrical plug and the electrical socket. The compression of the electrical plug cover allows the prongs to effectively engage the electrical socket, while limiting exposure to a user.

The current application claims a priority to the U.S. Provisional Patent application Ser. No. 61/841,499 filed on Jul. 1, 2013.

### FIELD OF THE INVENTION

The present invention relates generally to an accessory component to an electrical plug. Moreover the present invention relates to an apparatus that serves as a protective covering that occludes the prongs of an electrical plug.

### BACKGROUND OF THE INVENTION

There are different standards for power plugs around the world. In the US, they are standardized by the National Electrical Manufacturers Association (NEMA). Standards such as NEMA 1-15, NEMA 5-15 or NEMA 5-20 have been around for many years and are widely used in everyday life. These plugs generally comprise two non-coplanar metal blades positioned parallel to one another. Each of the metal blades are electrically conductive terminals that are used to engage a complementary electrical socket. However there are various disadvantages associated with the current connector types.

Some of the disadvantages associated with the current standardized connector types include safety flaws. Unlike some other power plugs these standardized NEMA 1-15, NEMA 5-15, and NEMA 5-20 have fully metal blades that may get partially exposed during use. This causes an issue when a user attempts to insert the electrical plug into the socket or similarly when trying to remove it, they sometimes unwittingly touch the exposed metal blades, resulting in a hazardous shock. This situation becomes more hazardous when the plug is not easily reachable and the user is not able to see the plug and the outlet properly. Similarly, when using surge protectors or extension cords with multiple extensions, reaching a particular plug among many can become difficult and sometimes the user may try to grope the plugs resulting in an increased risk. Another disadvantage occurs when the electrical plugs are connected to an electrical socket improperly. Quite often electrical plugs may be unable to fit all the way into the electrical socket as a result of various issues, or a user may plug them in perfectly, but over time the plug could get loose after use especially if it gets pulled by the connecting wire from an appliance. This situation leaves the metal blades exposed in the resulting gap. In this situation any object that contacts the metal blade will suffer from an electrical shock potentially causing an electrical burn.

It is the object of the present invention to provide an apparatus that functions as an electrical plug cover that protects a user from accidentally contacting the exposed prongs of an electrical plug. The electrical plug cover would occlude the metal blades of an electrical plug while the plug is being inserted into an electrical socket or in a situation where the electrical plug is improperly inserted into the electrical socket. The apparatus accomplishes this through a flexible low profile cover that partially surrounds the exposed prongs when they are being inserted into the electrical socket. The flexible low profile cover also known in the industry as a below is positioned on the interfacing surface of an existing electrical plug that becomes coincident with the interfacing surface of an electrical socket. Upon alignment and insertion into an electrical socket, the electrical plug cover is compressed between the interfacing surfaces of the electrical plug and the electrical socket. The compression of the electrical plug cover allows the prongs to effectively engage the electrical socket, but if the plug gets loose or the user is trying to remove it from the outlet or a gap is left between the two surfaces for any reason, the plug cover (named SafeUp) expands to cover the blades in the gap, avoiding any sort of a contact between the blades and an outside object that could be potentially the fingers of a user.

### BRIEF DESCRIPTIONS OF THE DRAWINGS

FIG. 1 is a perspective view displaying the preferred embodiment of the electrical plug cover in the resting state installed on an electrical plug in alignment with an electrical socket.

FIG. 2 is a perspective view displaying the preferred embodiment of the electrical plug cover in the compressed state installed on an electrical plug engaged with an electrical socket.

FIG. 3 is an enhanced cross sectional view displaying the preferred embodiment of the electrical plug cover installed on an existing electrical plug.

FIG. 4 is an enhanced perspective view displaying the preferred embodiment of the electrical plug cover in the resting state installed on an existing electrical plug.

FIG. 5 is an enhanced perspective view displaying the preferred embodiment of the electrical plug cover in the compressed state installed on an existing electrical plug.

FIG. 6 is a perspective view displaying the first end of the preferred embodiment of the electrical plug cover in the resting state.

FIG. 7 is a perspective view displaying the second end of the preferred embodiment of the electrical plug cover in the resting state.

FIG. 8 is a perspective view displaying the first end of the preferred embodiment of the electrical plug cover in the compressed state.

FIG. 9 is a perspective view displaying the second end of the preferred embodiment of electrical plug cover in the compressed state.

FIG. 10 is a perspective view displaying an embodiment of the electrical plug cover in the resting state installed on an electrical plug in alignment with an electrical socket.

FIG. 11 is a perspective view displaying an embodiment of the electrical plug cover in the compressed state installed around each prong of an existing electrical plug engaged with an electrical socket.

FIG. 12 is an enhanced perspective view displaying an embodiment of the electrical plug cover in the resting state c installed around each prong of an existing electrical plug.

FIG. 13 is an enhanced cross sectional view displaying an embodiment of the electrical plug cover in the resting state installed around each prong of an existing electrical plug.

### DETAIL DESCRIPTIONS OF THE INVENTION

All illustrations of the drawings are for the purpose of describing selected versions of the present invention and are not intended to limit the scope of the present invention.

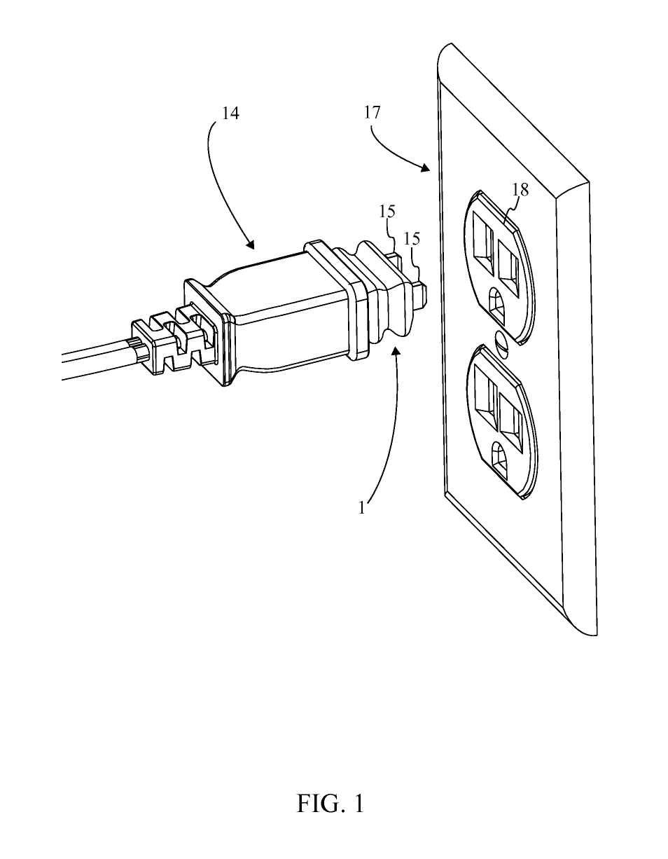

Referencing FIG. 1, the present invention is an electrical plug cover 1 that protects a user from accidentally contacting the exposed prongs 15 of an electrical plug 14 while they are being inserted into an electrical socket 17. The present invention accomplishes this through a flexible low profile cover that partially surrounds the exposed prongs 15 while they are being inserted into the electrical socket 17. The flexible low profile cover is positioned on the interfacing surface of an existing electrical plug 14 that becomes coincident with the interfacing surface 18 of an electrical socket 17. Through the positioning of the electrical plug cover 1, the terminal ends of the prongs 15 are partially exposed. Upon alignment and insertion into an electrical socket 17, the electrical plug cover 1 is compressed between the interfacing surfaces of the electrical plug 14 and the electrical socket 17. The compression of the electrical plug cover 1 allows the prongs 15 to effectively engage the electrical socket 17, while limiting exposure to a user.

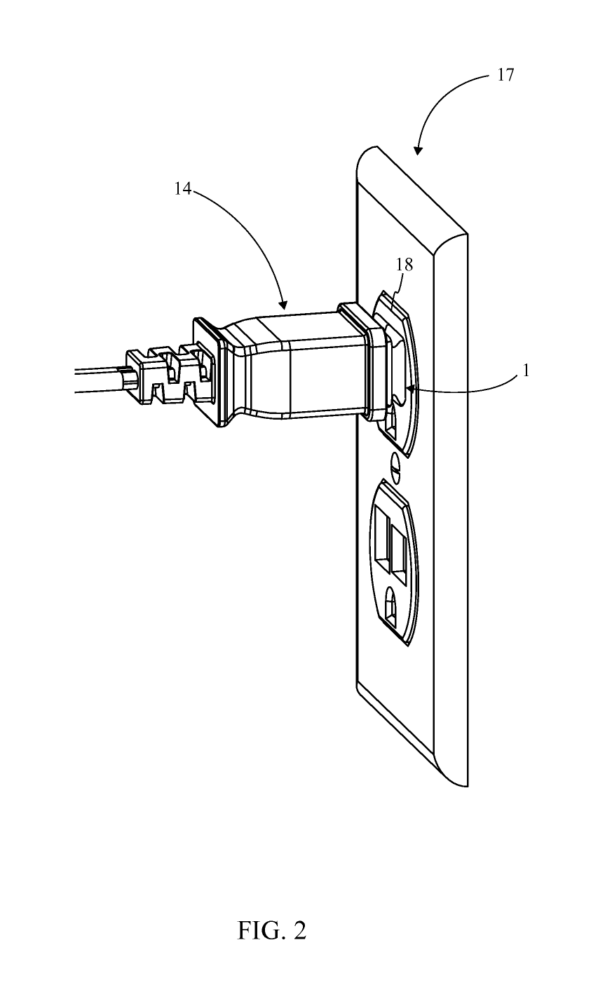

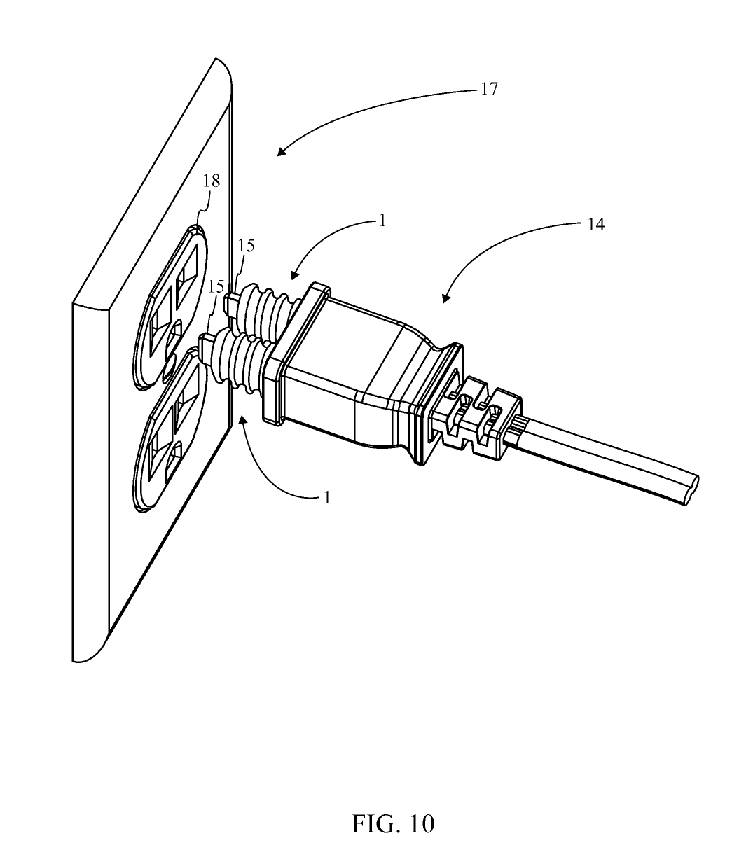

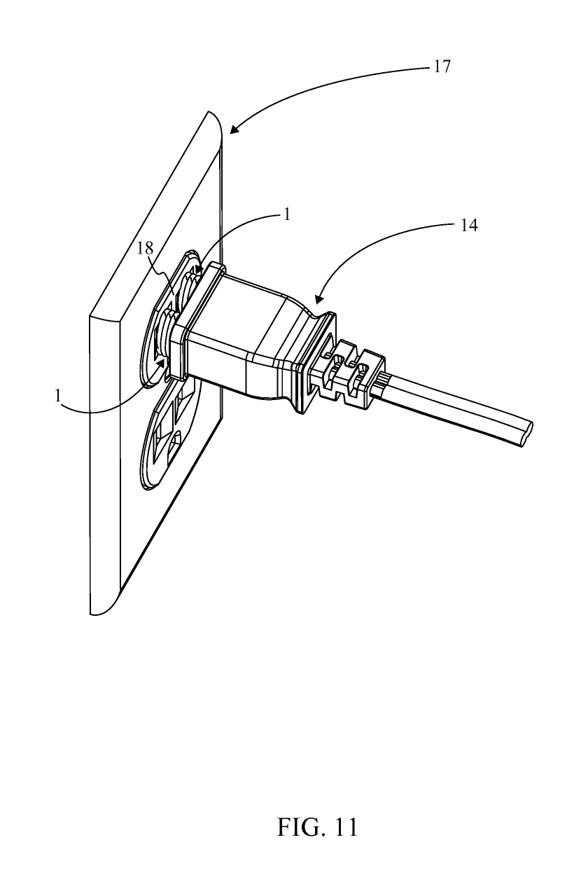

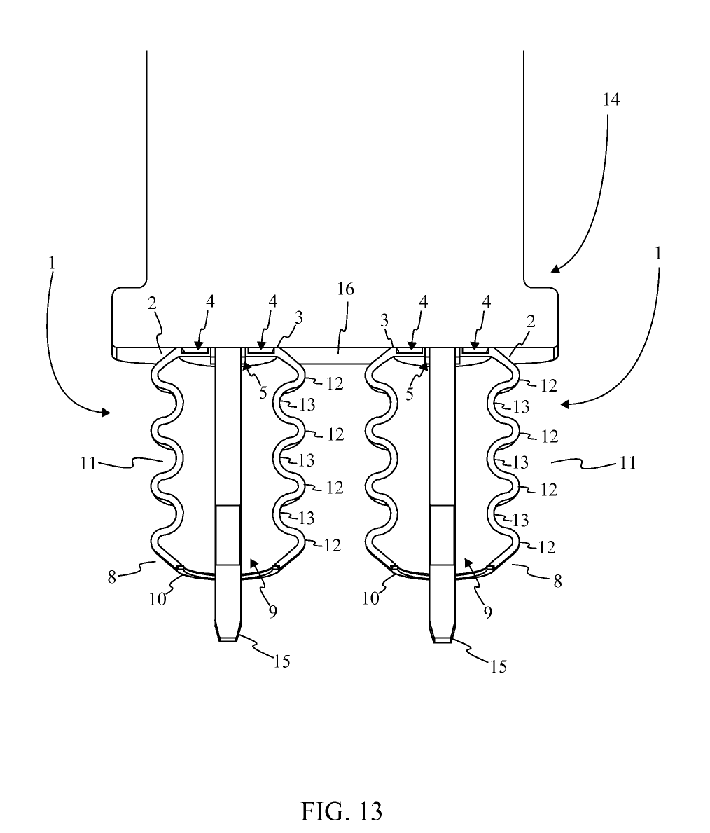

Referencing FIG. 1-3, FIG. 10-11, and FIG. 13, the electrical plug cover 1 comprises a first end 2, a second end 8, and a bellows 11. The first end 2 is particularly designed to engage the interfacing surface 16 of an electrical plug 14, where the interfacing surface 16 of an electrical plug 14 is the planar, typically rectangular shaped surface with perpendicularly protruding prongs 15 that becomes coincident with a complementary interfacing surface 18 of an electrical socket 17. The prongs 15 of the electrical plug 14 traverse into the electrical plug cover 1 by way of the first end 2. The bellows 11 is the portion of the electrical plug cover 1 that is positioned between the first end 2 and the second end 8. The bellows 11 is the flexible exterior that surrounds the prongs 15 of an electrical plug 14. The second end 8 is positioned opposite the first end 2 across the bellows 11. The second end 8 is particularly designed to engage the interfacing surface 18 of an electrical socket 17. The normal distance between the first end 2 and the second end 8 allows the terminal ends of the prongs 15 to traverse the second end 8, where the terminal end of the prong 15 is the distal portion of a perpendicularly protruding prong from the interfacing surface 16 of the electrical plug 14.

Referencing FIG. 1-5 and FIG. 10-11, the electrical plug cover 1 is provided with a resting state and a compressed state. The resting state is provided with the first end 2 engaging the interfacing surface 16 of an electrical plug 14 while the second end 8 is disengaged with the interfacing surface 18 of an electrical socket 17. In the resting state, the bellows 11 is fully extended, covering up a large portion of the prongs 15. With the bellows 11 fully extended the second end 8 is positioned adjacent with the terminal end of the prongs 15. In the compressed state the first end 2 is engaged with the interfacing surface 16 of the electrical plug 14 while the second end 8 is engaged with the interfacing surface 18 of the electrical socket 17. The compressed state is a result of the engagement between the prongs 15 and the electrical socket 17. In order to properly engage, the prongs 15 traverse into the electrical socket 17 requiring the interfacing surface 16 of the electrical plug 14 to be closely positioned to the interfacing surface 18 of the electrical socket 17. The resulting engagement causes the second end 8 to reposition near the first end 2 compressing the bellows 11 in the process. It should be noted that in the compressed state, the distance between the first end 2 and the second end 8 is approximately 2.4 mm.

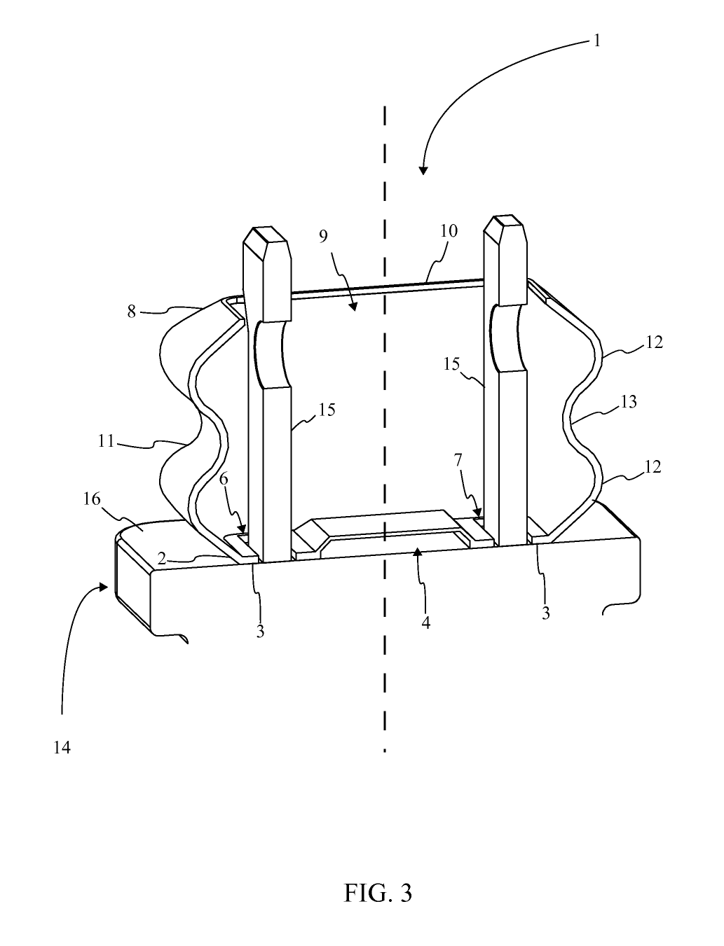

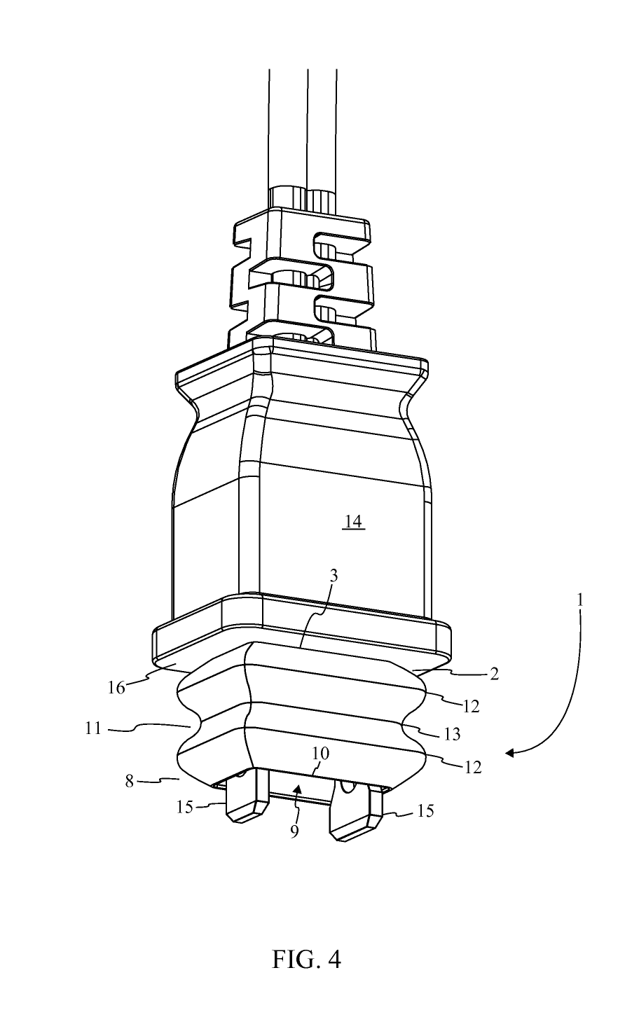

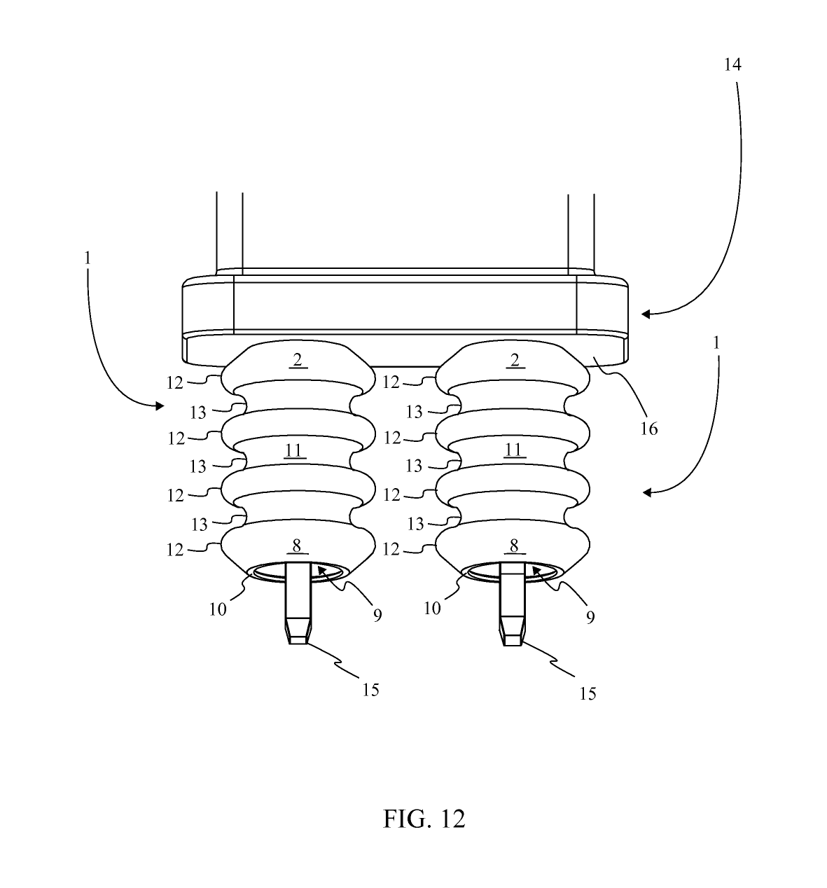

Referencing FIG. 3, FIG. 4, FIG. 12, and FIG. 13, the first end 2 is the portion of the electrical plug cover 1 that becomes coincident with the interfacing surface 16 of the electrical plug 14. The first end 2 is traversed by the perpendicularly protruding prongs 15 of the electrical plug 14. The first end 2 is centrally aligned with the bellows 11 and the second end 8. The first end 2 is positioned opposite the second end 8 across the bellows 11. In the current embodiment of the present invention, the first end 2 comprises a plug mount 3 and at least one prong opening 5. The plug mount 3 is the portion of the first end 2 that is coincident with the interfacing surface 16 of the electrical plug 14. The at least one prong opening 5 functions as a channel enabling the prongs 15 of the electrical plug 14 to traverse into the electrical plug cover 1. The at least one prong opening 5 is surrounded by the plug mount 3, wherein the plug mount 3 is found peripherally positioned around the at least one prong opening 5.

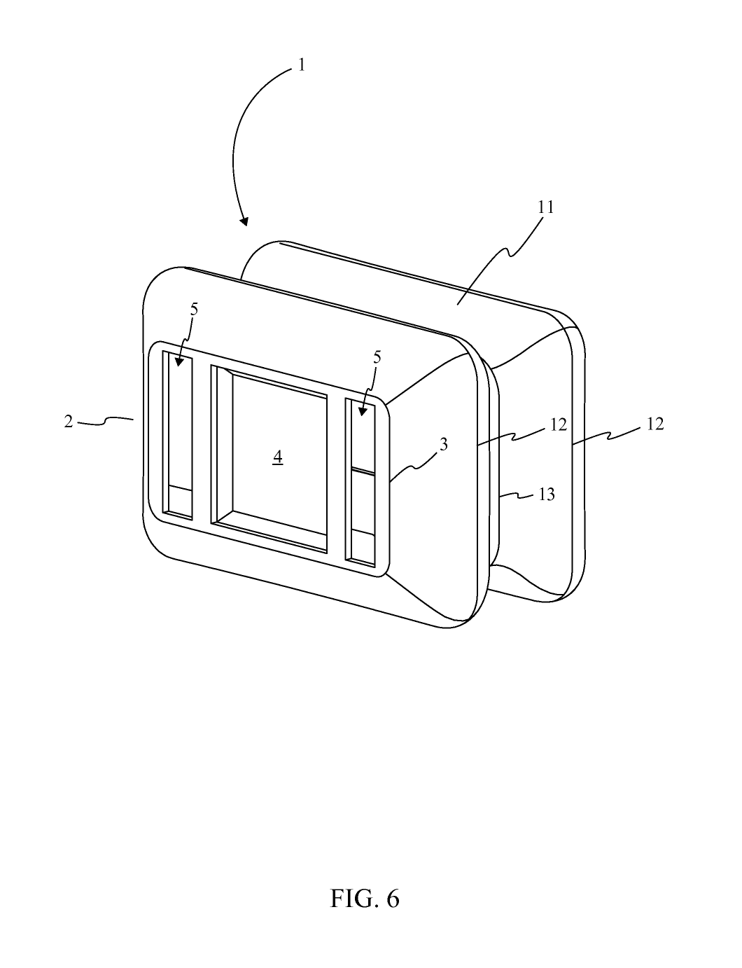

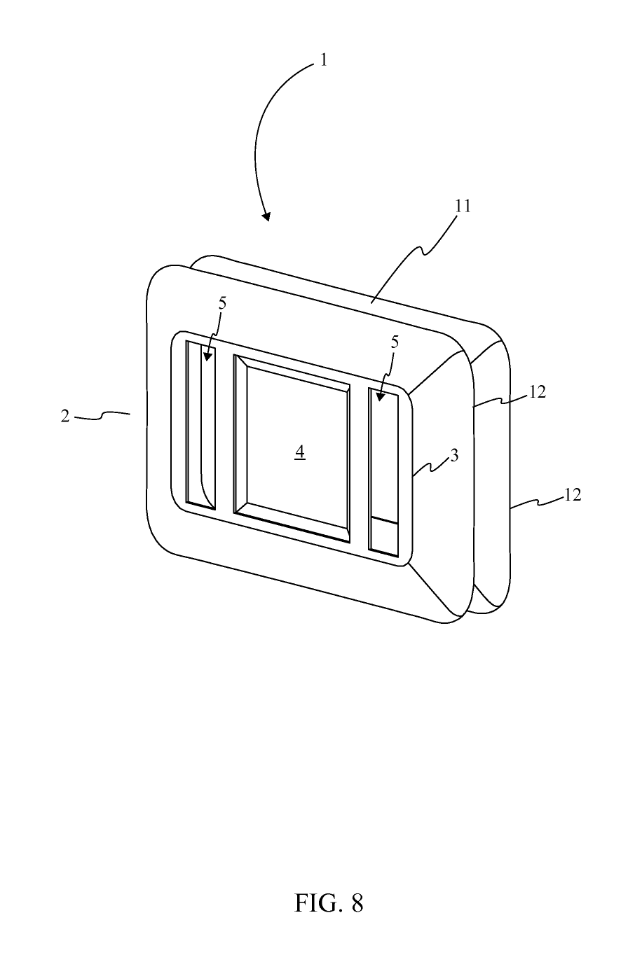

Referencing FIG. 3, FIG. 6, FIG. 8, and FIG. 13, the plug mount 3 is the portion of the first end 2 that engages the interfacing surface 16 of the electrical plug 14. The plug mount 3 is positioned in a manner that surrounds the at least one prong opening 5. In the preferred embodiment of the present invention, the at least one prong opening 5 comprises a first prong opening 6 and a second prong opening 7 while the plug mount 3 comprises a recessed cavity 4. the plug mount 3 is a mostly planar interfacing surface that is traversed by the first prong opening 6 and the second prong opening 7. The first prong opening 6 and the second prong opening 7 are provided as rectangular shaped channels positioned in parallel alignment. The first prong opening 6 and the second prong opening 7 are particularly positioned in order to accommodate the prong positioning of a 2-prong

National Electrical Manufacturers Association NEMA Type 1 connector, more specifically a NEMA 1-15P plug.

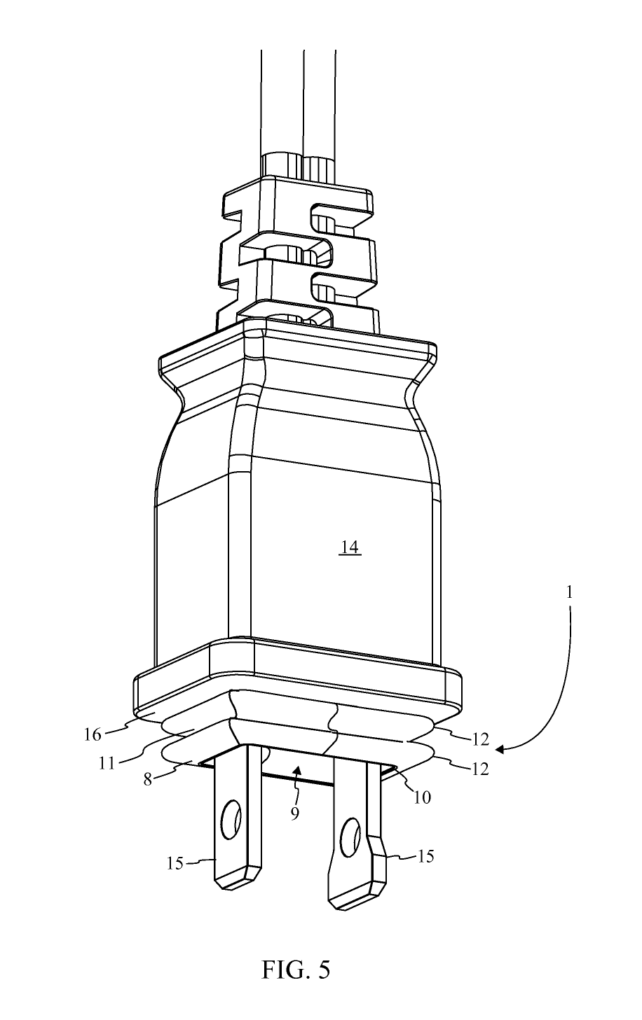

Referencing FIG. 5, FIG. 6, and FIG. 8, in the preferred embodiment of the present invention, the first prong opening 6 and the second prong opening 7 are each surrounded by the plug mount 3. The first prong opening 6 is positioned opposite the second prong opening 7 across the recessed cavity 4. The recessed cavity 4 is a concave area positioned between the first prong opening 6 and the second prong opening 7. The concavity of the recessed cavity 4 is oriented opposite the second end 8 in order to align coincident with the interfacing surface 16 of the electrical plug 14. The recessed cavity 4 is provided as a receptacle for an adhesive compound. The adhesive compound is used to securely join the electrical plug cover 1 to the electrical plug 14. The recessed cavity 4 is provided to receive a sufficient quantity of the adhesive compound that is suitable to join the first end 2 to the interfacing surface 16 of the electrical plug 14, reducing excess and overflow of the adhesive compound. It should be noted that the adhesive compound can be accomplished by a plurality of adhesive materials that include but are not limited to adhesive polymers as well as double sided adhesive tapes such as foam tape.

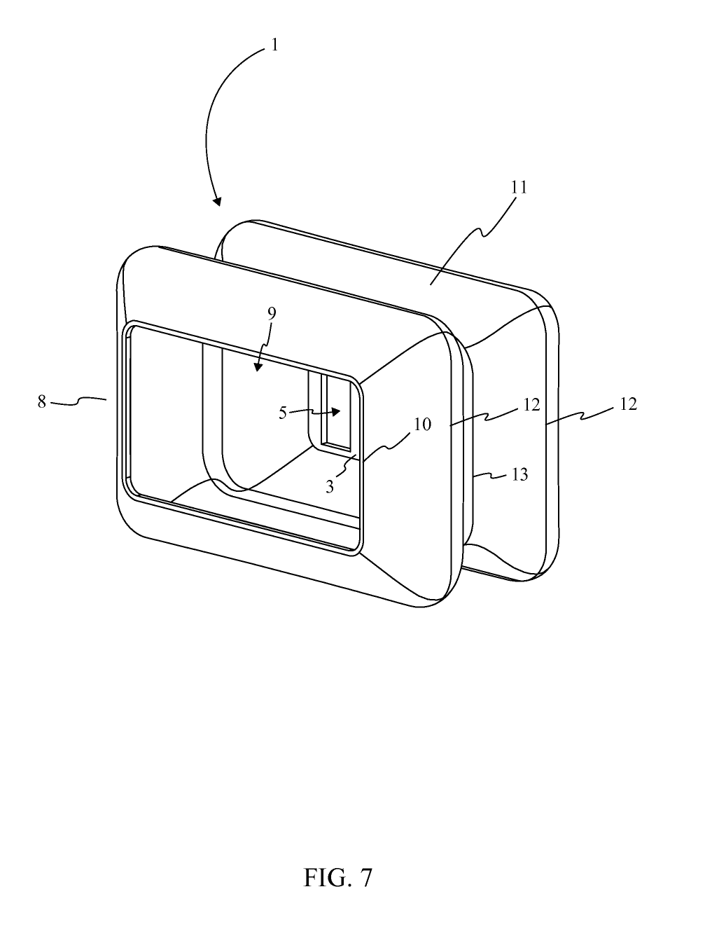

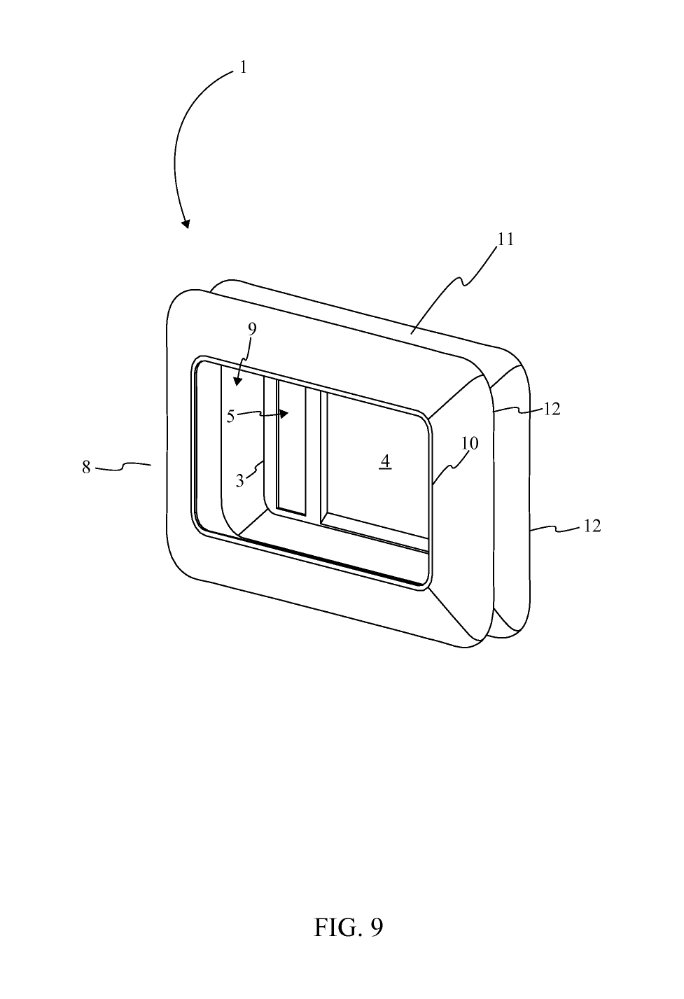

Referencing FIG. 3, FIG. 7, FIG. 9, and FIG. 13, the second end 8 is the portion of the electrical plug cover 1 that becomes coincident with the interfacing surface 16 of the electrical plug 14. The second end 8 is positioned opposite the first end 2 across the bellows 11. The second end 8 is traversed by the terminal end of the prongs 15. In the current embodiment of the present invention, the second end 8 comprises a cover opening 9 and a socket mount 10. The socket mount 10 is provided as a planar surface that engages the interfacing surface 18 of the electrical socket 17. The engagement of the socket mount 10 with the interfacing surface 18 of the electrical socket 17 primarily functions to retain the second end 8 in place when bellows 11 is being compressed by the first end 2. The socket mount 10 is centrally aligned with the plug mount 3 in order to evenly compress the bellows 11. The socket mount 10 is found peripherally positioned around the cover opening 9, wherein the socket mount 10 surrounds the cover opening 9. The cover opening 9 provides a passage for the prongs 15. During the resting state, the prongs 15 only partially traverse the cover opening 9, wherein the terminal ends of the prongs 15 are traverse the cover opening 9. During the compressed state, the prongs 15 mostly traverse the cover opening 9 while engaging the electrical socket 17.

Referencing FIG. 3-5, FIG. 12, and FIG. 13, the bellows 11 is the flexible exterior surface that is positioned between the first end 2 and the second end 8 and surrounds the portion of the prongs 15 found positioned between the first end 2 and the second end 8. The bellows 11 has an accordion-like membrane that allows the exterior of the bellows 11 to neatly fold upon itself. The bellows 11 is found centrally aligned with the first end 2 and the second end 8. The central alignment allows the bellows 11 to fold upon itself on a path that reduces the chance of unwanted interactions with the prongs 15. In the current embodiment of present invention, the bellows 11 comprises exterior flexing edges 12 and interior flexing edges 13. The exterior flexing edges 12 and the interior flexing edges 13 are the pivoting edges of the bellow's 11 flexible exterior. The interior flexing edges 13 are found centrally aligned with the exterior flexing edges 12. The interior flexing edges 13 correspond to the edges of the bellows 11 that are proximal to the axis of the central alignment, while the exterior flexing edges 12 correspond to the edges of the bellows 11 that are distal to the axis of the central alignment. The positioning of the interior flexing edges 13 relative to the exterior flexing edges 12 allows the bellows 11 to transition into the compressed state and re-expand to the resting state. The exterior flexing edges 12 and the interior flexing edges 13 are positioned in alternating order relative to one another, where interior flexing edges 13 and exterior flexing edges 12 are never consecutively positioned between the first end 2 and the second end 8.

Referencing FIG. 4, FIG. 5, and FIG. 13 , in the current embodiment of the present invention, the bellows 11 comprises at least one interior flexing edge 13 and at least two exterior flexing edges 12. During the compressed state, each of the at least two exterior flexing edges 12 become coincident with each other due to the compression of the bellows 11. The at least one interior flexing edge 13 is positioned between the at least two exterior flexing edges 12. The positioning of the interior flexing edge 13 relative to the exterior flexing edges 12 is reduces the potential of unwanted contact by positioning the majority of the flexing edges of the bellows 11 distal to the prongs 15. It should be noted that the connection between the first end 2 and the bellows 11, as well as the connection between the second end 8 and the bellows 11 functions as a flexing edge but are not described as such since both interior flexing edges 13 and exterior flexing edges 12 pivot in two directions while the aforementioned connection only pivots in one direction. The differentiation is necessary as the both the first end 2 and the second end 8 provide stability to the bellows 11 while it is transitioning into the compressed state due to their engagement with the interfacing surface 16 of the electrical plug 14 and the interfacing surface 18 of the electrical socket 17, respectively.

In the current embodiment of the present invention, the bellows 11 is constructed of a flexible light weight non-conducive material. The material requirements of the bellows 11 can be accomplished by a plurality of materials that include but are not limited to flexible non-conducive elastomeric polymers or plastics, which include but not limited to silicone rubber.

In the current embodiment of the present invention, the electrical plug cover 1 is provided as being attachable to an existing electrical plug 14. In additional embodiments, the electrical plug cover 1 could be provided as an integrated component of an electrical plug 14. In the aforementioned additional embodiment, the first end 2 would be integrally coupled to the interfacing surface 16 of the electrical plug 14. Although the plug mount 3 would be retained in the integrated configuration, the at least one prong opening 5 would be unnecessary since the alignment of the prongs 15 of the electrical plug 14 relative to the electrical plug cover 1 could be accomplished by the plug mount 3 or another means during the integration of the electrical plug cover 1 to the electrical plug 14.

Referencing FIG. 10-13, in an embodiment of the present invention, the electrical plug cover 1 is configured to sleeve a single electrical prong 15. A single electrical prong 15 of an electrical plug 14 would traverse the at least one prong opening 5 while the plug mount 3 would secure the electrical plug cover 1 to the interfacing surface 16 of the electrical plug 14. The second end 8 would be similarly configured, where the cover opening 9 would be partially traversed by the single prong 15 of the electrical plug 14. In the aforementioned embodiment, the bellows 11 would be particularly configured in a manner that would reduce the unwanted interaction with the prong 15 as well as unwanted interactions with neighboring electrical plug covers 1. In the current embodiment of the present invention, the electrical plug cover is configured to fit a 2-prong NEMA type 1 connector. In additional embodiments the electrical plug cover could be particularly configured to fit a plurality of NEMA connector types. The electrical plug cover could configured to fit NEMA connector types that include but are not limited to NEMA 5 connectors, NEMA 6 connectors, NEMA 10 connectors, NEMA 14 connectors, NEMA TT-30 connectors, NEMA ML-1 connectors,

NEMA ML-2 connectors, NEMA ML-3 connectors, NEMA L5 connectors, NEMA L6 connectors, NEMA L7 connectors, NEMA L8 connectors, NEMA L9 connectors, NEMA L14 connectors, NEMA L15 connectors, NEMA L16 connectors, NEMA L17 connectors, NEMA L18 connectors, NEMA L21 connectors, NEMA L22 connectors, and NEMA L23 connectors.

In additional embodiments the electrical plug cover may be configured to fit a plurality of international electrical connector types. The plurality of international connector types that the electrical plug cover could be configured for include but are not limited to Argentine IRAM 2073 & 2071(Type I) connectors, Australian standard AS/NZS 3112 (Type I) connectors, Brazilian standard NBR 14136 (Type N) connectors,

British and compatible standards connectors, CEE 7 standard Europlug connectors, Danish Section 107-2-D1 earthed(Type K) connectors, Italian CEI 23-16/VII(Type L) connectors, Soviet standard GOST 7396 C 1 unearthed connectors, Swiss SEV 1011 (Type J) connectors, IEC 60906-1 (Type N) connectors, Chinese CPCS-CCC (Type I) connectors, and Israeli 5132 (Type H) connectors.

Although the invention has been explained in relation to its preferred embodiment, it is to be understood that many other possible modifications and variations can be made without departing from the spirit and scope of the invention as hereinafter claimed.

What is claimed is:

1. An electrical plug cover comprises:
a first end;
a second end;
a bellows;
the first end comprises a plug mount and at least one prong opening;
the second end comprises a cover opening and a socket mount;
the bellows comprises exterior flexing edges and interior flexing edges;
the plug mount being positioned opposite the cover opening;
the at least one prong opening being surrounded by the plug mount;
the bellows being positioned between the first end and the second end;
the interior flexing edge being centrally positioned to the exterior flexing edge;
the cover opening being peripherally bordered by the socket mount; and
the socket mount being centrally aligned with the plug mount.

2. The electrical plug cover as claimed in claim 1 comprises:
the at least one prong opening comprises a first prong opening and a second prong opening;
the first prong opening being positioned parallel to the second prong opening; and
the first prong opening, the second prong opening, and the plug mount being centrally positioned to the interior flexing edge and the exterior flexing edge.

3. The electrical plug cover as claimed in claim 2 comprises:
the plug mount comprises a recessed cavity;
the recessed cavity being positioned between the first prong opening and the second prong opening; and
the recessed cavity contains an adhesive compound.

4. The electrical plug cover in claim 1, wherein the electrical plug cover being constructed of a lightweight non-conductive flexible material.

5. The electrical plug cover in claim 1, wherein the bellows comprises at least one interior flexing edge and at least two exterior flexing edges.

6. The electrical plug cover in claim 1, wherein the electrical plug cover is integrally coupled to an existing electrical plug.

7. An electrical plug cover comprises:
a first end;
a second end;
a bellows;
the electrical plug cover being constructed of a lightweight non-conductive flexible material;
the first end comprises a plug mount and at least one prong opening;
the second end comprises a cover opening and a socket mount;
the bellows comprises exterior flexing edges and interior flexing edges;
the at least one prong opening comprises a first prong opening and a second prong opening;
the plug mount being positioned opposite the cover opening;
the at least one prong opening being surrounded by the plug mount;
the bellows being positioned between the first end and the second end;
the interior flexing edge being centrally positioned to the exterior flexing edge;
the cover opening being peripherally bordered by the socket mount;
the socket mount being centrally aligned with the plug mount;
the first prong opening being positioned parallel to the second prong opening;
the first prong opening, the second prong opening, and the plug mount being centrally positioned to the interior flexing edge and the exterior flexing edge;

8. The electrical plug cover as claimed in claim 7 comprises:
the plug mount comprises a recessed cavity;
the recessed cavity being positioned between the first prong opening and the second prong opening; and
the recessed cavity contains an adhesive compound.

9. The electrical plug cover in claim 7, wherein the bellows comprises at least one interior flexing edge and at least two exterior flexing edges;

10. The electrical plug cover in claim 7, wherein the electrical plug cover is integrally coupled to an existing electrical plug.

11. An electrical plug cover comprises:
a first end;
a second end;
a bellows;
the electrical plug cover being constructed of a lightweight non-conductive flexible material;
the first end comprises a plug mount and at least one prong opening;
the second end comprises a cover opening and a socket mount;
the bellows comprises at least one interior flexing edge and at least two exterior flexing edges;
the at least one prong opening comprises a first prong opening and a second prong opening;
the plug mount comprises a recessed cavity;
the plug mount being positioned opposite the cover opening;
the at least one prong opening being surrounded by the plug mount;
the bellows being positioned between the first end and the second end;
the interior flexing edge being centrally positioned to the exterior flexing edge;
the cover opening being peripherally bordered by the socket mount;
the socket mount being centrally aligned with the plug mount;
the first prong opening being positioned parallel to the second prong opening;
the first prong opening, the second prong opening, and the plug mount being centrally positioned to the interior flexing edge and the exterior flexing edge;
the recessed cavity being positioned between the first prong opening and the second prong opening; and
the recessed cavity contains an adhesive compound.

12. The electrical plug cover in claim 11, wherein the electrical plug cover is integrally coupled to an existing electrical plug.
